(19) United States
(12) Patent Application Publication
(10) Pub. No.: US 2005/0254369 A1
(43) Pub. Date: Nov. 17, 2005

(54) Disc reproducing apparatus

(75) Inventor: Naoto Takada, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/121,946

(22) Filed: May 5, 2005

(30) Foreign Application Priority Data
May 12, 2004 (JP) P2004-142583

(51) Int. Cl. G11B 5/09

(52) U.S. Cl. 369/47.1; 369/53.1; 369/275.1

(57) ABSTRACT

A disc reproducing apparatus is constructed so that an identification code of an optical disc is read out and contents of the optical disc are selected and the contents reproduced by a reproduction program of the optical disc are selected and a reproduction mode of the contents reproduced by the reproduction program of the optical disc is selected and the contents of the optical disc and the reproduction program for reproducing the optical disc together with the identification code of the optical disc are stored and the reproduction program of the optical disc set is executed and the optical disc is reproduced.

### BACKGROUND OF THE INVENTION

1. Field of the Invention

The present invention relates to a disc reproducing apparatus for reproducing an optical disc, and particularly to a disc reproducing apparatus for reproducing an SACD (Super Audio Compact Disc) hybrid disc in which an HD (High Density) layer and a CD (Compact Disc) layer are formed in a two-layer structure.

2. Description of the Related Art

As is well known, it is constructed so that a frequency bandwidth of music data recorded on an HD layer of an SACD is wider than that of music data recorded on a CD layer and while the frequency bandwidth of the music data recorded on the CD layer is 20 kHz, the frequency bandwidth of the music data recorded on the HD layer is 100 kHz and music can be heard by reproducing the HD layer with higher quality than by reproducing the CD layer. However, there was a problem that a reproduction mode must be selected and switched for every music when a user wants to reproduce and hear music in a desired reproduction mode in the case of reproducing the music recorded on an SACD hybrid disc.

As a background art, there was means constructed so that information data such as track elapsed time, a music number about a digital audio signal recorded on an HD disc of a record format different from that of a CD can be converted into a format similar to the CD to display the information such as the track elapsed time, the music number in a manner similar to the CD (for example, see JP-A-2000-156050).

Also, there was means which is constructed so that speaker setting respectively different at the time of reproducing an SACE and the time of reproducing a DVD (Digital Versatile Disc) can be made automatically and is constructed so as to identify the SACD and the DVD and automatically make speaker setting respectively different according to a kind of the disc (for example, see JP-A-2002-369299).

### SUMMARY OF THE INVENTION

However, in the former of the means described in the background art, information data such as track elapsed time, a music number about a digital audio signal recorded on an HD disc of a record format different from that of a CD can be converted into a format similar to the CD to display the information such as the track elapsed time, the music number in a manner similar to the CD, but the former was not means constructed so as to solve the problem that a reproduction mode must be selected and switched every music when a user wants to reproduce and hear music in a desired reproduction mode in the case of reproducing the music recorded on an SACD hybrid disc.

Also, in the latter, it is constructed so that speaker setting respectively different at the time of reproducing an SACE and the time of reproducing a DVD can be made automatically and the SACD and the DVD are identified and speaker setting respectively different according to a kind of the disc can be made automatically, but the latter was not means constructed so as to solve the problem similarly.

The invention is implemented in view of such a problem which the background art has, and an object of the invention is to provide a disc reproducing apparatus capable of selecting a reproduction mode for every music and music in which a user desires reproduction and reproducing the music in a reproduction mode desired by the user in order of music desired by the user in the case of reproducing music recorded on an HD layer and a CD layer of an SACD hybrid disc.

In order to achieve the object, the invention is a disc reproducing apparatus capable of simultaneously reproducing an HD layer and a CD layer of an SACD hybrid disc in which the HD layer and the CD layer are formed in a two-layer structure, and the disc reproducing apparatus includes readout means for reading out contents and an identification code of an optical disc, storage means for storing the contents of the optical disc and a reproduction program for reproducing the optical disc together with the identification code of the optical disc, display means for displaying the reproduction program and the contents of the optical disc, contents selection means for selecting the contents of the optical disc displayed by the display means and selecting the contents reproduced by the reproduction program of the optical disc, reproduction mode selection means for selecting a reproduction mode of the contents reproduced by the reproduction program of the optical disc displayed by the display means, and reproduction program execution means for executing the reproduction program of the optical disc and reproducing the optical disc.

The display means could be constructed so as to read out and display the reproduction program and the contents of the optical disc stored in the storage means when the identification code of the optical disc read out by the readout means is stored in the storage means.

The reproduction mode selection means could be constructed so as to select a reproduction mode for reproducing two channels of the HD layer of the SACD.

Also, the reproduction mode selection means could be constructed so as to select a reproduction mode for downmixing the HD layer of the SACD into a right channel and the CD layer into a left channel and performing reproduction.

Here, “downmixing” is to convert a multi-channel surround source to channels adapted to the mode of listening. The sound of each surround channel is down converted based on a predetermined rule and allocated to each speaker. This “downmixing” is one function of Dolby Digital.

Also, the reproduction mode selection means could be constructed so as to select a reproduction mode for reproducing the CD layer of the SACD.

Also, the reproduction mode selection means could be constructed so as to select a reproduction mode for simultaneously reproducing the HD layer and the CD layer of the SACD.

The storage means could be nonvolatile memory.

By these means, a reproduction mode every music and music in which a user desires reproduction can be selected to reproduce the music in a reproduction mode desired by the user in order of music desired by the user in the case of reproducing music recorded on an HD layer and a CD layer of an SACD hybrid disc.

According to a disc reproducing apparatus according to a first aspect of the invention, it is constructed so that contents and an identification code of an optical disc are read out and the contents of the optical disc and a reproduction program for reproducing the optical disc are stored together with the identification code of the optical disc and the reproduction program and the contents of the optical disc are displayed and also when the identification code of the optical disc is stored, the reproduction program and the contents of the optical disc stored are read out and displayed and the contents reproduced by the reproduction program of the optical disc are selected from among the contents of the optical disc displayed and a reproduction mode of the contents reproduced by the reproduction program of the optical disc is selected from among a reproduction mode for reproducing two channels of the HD layer of an SACD, a reproduction mode for downmixing the HD layer of the SACD into a right channel and the CD layer into a left channel and performing reproduction, a reproduction mode for reproducing the CD layer of the SACD and a reproduction mode for simultaneously reproducing the HD layer and the CD layer of the SACD and the reproduction program of the optical disc set is executed and the optical disc is reproduced, so that a reproduction mode every music and music in which a user desires reproduction can be selected to reproduce the music in a reproduction mode desired by the user in order of music desired by the user in the case of reproducing music recorded on an HD layer and a CD layer of an SACD hybrid disc.

According to a disc reproducing apparatus according to a second aspect of the invention, it is constructed so that an identification code of an optical disc is read out and contents of the optical disc are selected and the contents reproduced by a reproduction program of the optical disc are selected and a reproduction mode of the contents reproduced by the reproduction program of the optical disc is selected and the contents of the optical disc and the reproduction program for reproducing the optical disc are stored together with the identification code of the optical disc and the reproduction program of the optical disc set is executed and the optical disc is reproduced, so that a reproduction mode every music and music in which a user desires reproduction can be selected to reproduce the music in a reproduction mode desired by the user in order of music desired by the user in the case of reproducing music recorded on an HD layer and a CD layer of an SACD hybrid disc.

According to a disc reproducing apparatus according to a third aspect of the invention, it is constructed so as to read out and display the reproduction program and the contents of the optical disc stored in the storage means when the identification code of the optical disc is stored in the storage means, so that the existing reproduction program of the optical disc can be edited.

According to a disc reproducing apparatus according to a fourth aspect of the invention, it is constructed so as to be able to reproduce two channels of the HD layer of the SACD, so that the HD layer of the SACD can be reproduced in a right channel and the two channels of the HD layer can be reproduced to listen to the music.

According to a disc reproducing apparatus according to a fifth aspect of the invention, it is constructed so as to be able to downmix the HD layer of the SACD into a right channel and the CD layer into a left channel and perform reproduction, so that a user can downmix the HD layer of the SACD into the right channel and the CD layer into the left channel and perform reproduction and listen to the music in the case of reproducing contents by a reproduction program of the optical disc.

According to a disc reproducing apparatus according to a sixth aspect of the invention, it is constructed so as to be able to reproduce the CD layer of the SACD, so that a user can reproduce the CD layer of the SACD and listen to the music in the case of reproducing contents by a reproduction program of the optical disc.

According to a disc reproducing apparatus according to a seventh aspect of the invention, it is constructed so as to be able to select a reproduction mode for simultaneously reproducing the HD layer and the CD layer of the SACD, so that a user can simultaneously reproduce the HD layer and the CD layer of the SACD and listen to the music in the case of reproducing contents by a reproduction program of the optical disc.

According to a disc reproducing apparatus according to an eighth aspect of the invention, it is constructed so as to store the reproduction program and the contents of the optical disc together with the identification code in nonvolatile memory, so that the reproduction program and the contents of the optical disc stored in the nonvolatile memory can be held even when a power source of the disc reproducing apparatus is turned off.

### BRIEF DESCRIPTION OF THE DRAWINGS

FIG. 1 is a block diagram showing a configuration of a disc reproducing apparatus of one embodiment of the invention;

FIG. 2 is an explanatory diagram showing a remote control device of the disc reproducing apparatus;

FIG. 3 is an explanatory diagram showing one example of a reproduction program of the disc reproducing apparatus; and

FIG. 4 is a flowchart showing an action of the disc reproducing apparatus.

### DETAILED DESCRIPTION OF THE PREFFERED EMBODIMENTS

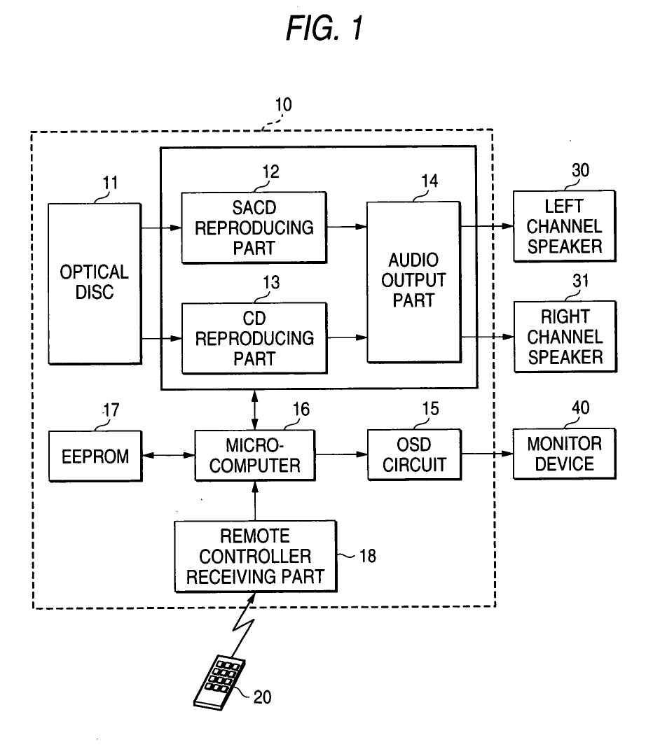

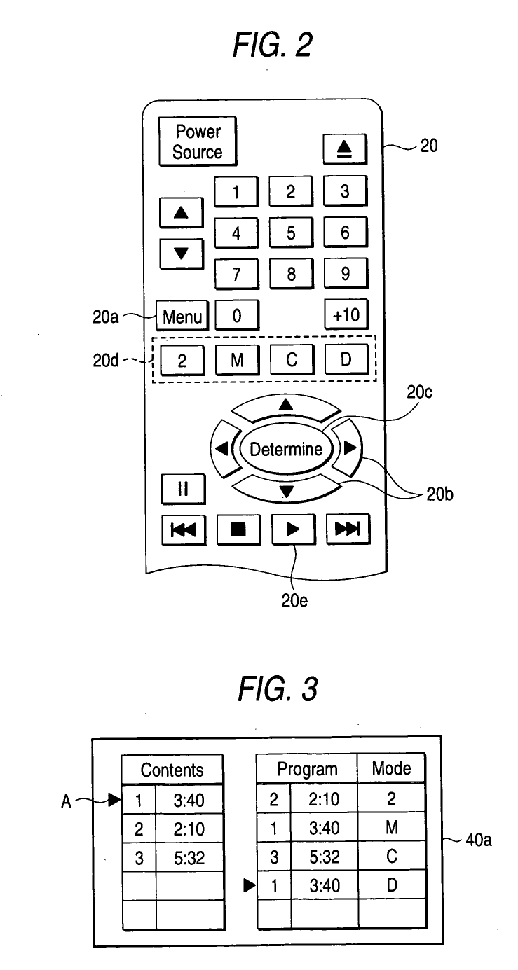

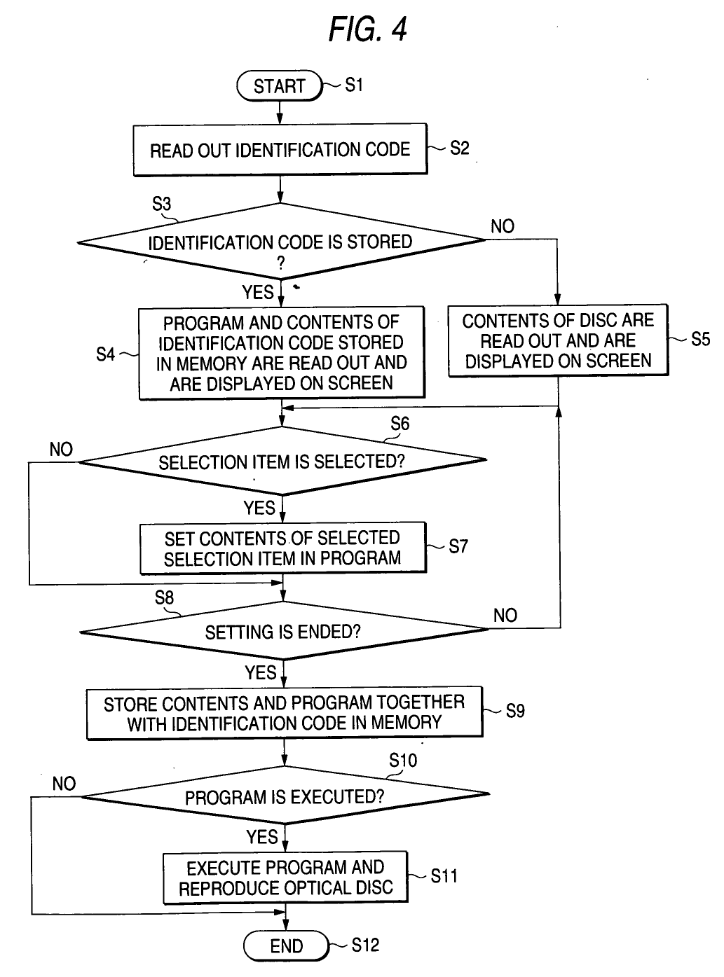

The best mode for carrying out the invention will be described below in detail with reference to the drawings properly. FIG. 1 is a block diagram showing a configuration of a disc reproducing apparatus of one embodiment of the invention, and FIG. 2 is an explanatory diagram showing a remote control device of the disc reproducing apparatus of one embodiment of the invention, and FIG. 3 is an explanatory diagram showing one example of a reproduction program of the disc reproducing apparatus of one embodiment of the invention, and FIG. 4 is a flowchart showing an action of the disc reproducing apparatus of one embodiment of the invention.

First, description will be made based on a block diagram showing a configuration of a disc reproducing apparatus of one embodiment of the invention of FIG. 1.

A disc reproducing apparatus 10 includes an SACD reproducing part 12 for reproducing music data recorded on an HD layer of an optical disc 11, a CD reproducing part 13 for reproducing music data recorded on a CD layer of the optical disc 11, an audio output part 14 for converting the music data reproduced by the SACD reproducing part 12 and the CD reproducing part 13 into an audio signal and outputting the signal to a left channel speaker 30 and a right channel speaker 31, an OSD (On-Screen Character Display) circuit 15 for superimposing a character information signal on a video signal and displaying character information on a screen of a monitor device 40, a microcomputer 16 for controlling the whole system of the disc reproducing apparatus 10, EEPROM (Electrically Erasable and Programmable Read-Only Memory) 17 which is nonvolatile memory for storing various data of a reproduction program etc., and a remote control receiving part 18 for receiving a remote control signal sent from a remote control device 20 and converting the remote control signal into a predetermined electrical signal.

Also, description will be made based on an explanatory diagram showing the remote control device of the disc reproducing apparatus of one embodiment of the invention of FIG. 2.

The remote control device 20 is provided with plural operation keys such as a menu key 20a for commanding the monitor device 40 to display a menu screen, cursor keys 20b for selecting a selection item displayed on the menu screen of the monitor device 40, a determination key 20c for determining a selection of the selection item selected by the cursor keys 20b, plural reproduction mode selection keys 20d for selecting a two-channel reproduction mode for reproducing two channels of the HD layer of the optical disc 11, a multi-channel reproduction mode for downmixing the HD layer of the optical disc 11 into a right channel and the CD layer into a left channel and performing reproduction, a CD layer reproduction mode for reproducing the CD layer of the optical disc 11 and a simultaneous reproduction mode for simultaneously reproducing the HD layer and the CD layer of the optical disc 11, and a reproduction key 20e for commanding reproduction of the optical disc 11 and also commanding execution of a reproduction program displayed on a screen of the monitor device 40, and it is constructed so that a desired action of the disc reproducing apparatus 10 can be performed by operating their operation keys. Incidentally, the cursor keys 20b are constructed of four operation keys of an up arrow key, a down arrow key, a left arrow key, and a right arrow key.

An action of the disc reproducing apparatus constructed as mentioned above will be described below.

When the optical disc 11 is loaded into the disc reproducing apparatus 10, the microcomputer 16 sends out a control signal to the SACD reproducing part 12 or the CD reproducing part 13, and reads out an identification code of the optical disc 11 loaded into the disc reproducing apparatus 10. Then, when the identification code of the optical disc 11 is stored in the EEPROM 17, the microcomputer 16 reads out a reproduction program and contents of the optical disc of its identification code stored in the EEPROM 17, and sends out a character information signal and a control signal to the OSD circuit 15, and displays an edit screen of the reproduction program and the contents of the optical disc 11 on a screen of the monitor device 40 (see FIG. 3). Also, when the identification code of the optical disc 11 is not stored in the EEPROM 17, the microcomputer 16 sends out a control signal to the SACD reproducing part 12 or the CD reproducing part 13, and reads out contents of the optical disc 11 loaded into the disc reproducing apparatus 10, and sends out a character information signal and a control signal to the OSD circuit 15, and displays a creation screen of a reproduction program and the contents of the optical disc 11 on the screen of the monitor device 40 (see FIG. 3).

When contents in which a cursor A is displayed in the right of contents of the optical disc 11 displayed on a screen 40a of the monitor device 40 are selected by an operation of the cursor keys 20b of the remote control device 20 and selection of the contents of the cursor A is determined by the determination key 20c of the remote control device 20, the microcomputer 16 writes into a reproduction program for reproducing the selected contents of the optical disc 11 (see FIG. 3). Then, when a reproduction mode of the contents is selected by one of the reproduction mode selection keys 20d of the remote control device 20, a reproduction mode for reproducing the contents of the reproduction program is set in the reproduction mode selected (see FIG. 3). A user operates the operation keys of the remote control device 20, and selects the contents reproduced by the reproduction program for reproducing the optical disc 11 in order of music desired, and selects a desired reproduction mode for reproducing the contents, and edits and creates the reproduction program for reproducing the optical disc 11.

When the contents reproduced by the reproduction program for reproducing the optical disc 11 and the reproduction mode for reproducing the contents are selected and editing and creation of the reproduction program for reproducing the optical disc 11 are ended, the microcomputer 16 stores the reproduction program and the contents of the optical disc 11 together with the identification code in the EEPROM 17. Then, when the reproduction key 20e of the remote control device 20 for commanding execution of the reproduction program displayed on the screen 40a of the monitor device 40 is operated, the microcomputer 16 sends out a control signal to the SACD reproducing part 12 or the CD reproducing part 13, and executes the reproduction program displayed on the screen 40a of the monitor device 40 and reproduces the optical disc 11, and sends out a control signal to the audio output part 14, and outputs an audio signal to the left channel speaker 30 and the right channel speaker 31 by the audio output part 14 according to the reproduction mode of the reproduction program.

Also, description will be made based on a flowchart showing an action of the disc reproducing apparatus of one embodiment of the invention of FIG. 4.

When an optical disc is loaded into a disc reproducing apparatus, the flowchart proceeds from step S1 to step S2 and in step S2, an identification code of the optical disc loaded into the disc reproducing apparatus is read out and the flowchart proceeds to step S3.

In step S3, it is decided whether or not the identification code of the optical disc is stored in memory, and when the identification code of the optical disc is stored in the memory, the flowchart proceeds to step S4 and when the identification code of the optical disc is not stored in the memory, the flowchart proceeds to step S5.

In step S4, a reproduction program and contents of the optical disc of the identification code stored in the memory are read out and an edit screen of the reproduction program and the contents of the optical disc are displayed on a screen of a monitor device and the flowchart proceeds to step S6.

In step S5, contents of the optical disc loaded into the disc reproducing apparatus are read out and a creation screen of a reproduction program and the contents of the optical disc are displayed on the screen of the monitor device and the flowchart proceeds to step S6.

In step S6, the contents of the optical disc displayed on the screen of the monitor device are selected and it is decided whether or not a selection item of the reproduction program is selected, and when the selection item of the reproduction program is selected, the flowchart proceeds to step S7 and when the selection item of the reproduction program is not selected, the flowchart proceeds to step S8.

In step S7, the contents of the selection item selected are set in the reproduction program and the flowchart proceeds to step S8.

In step S8, it is decided whether or not setting of the selection item of the reproduction program is ended, and when setting of the selection item of the reproduction program is ended, the flowchart proceeds to step S9 and when setting of the selection item of the reproduction program is not ended, the flowchart returns to step S6 and the steps from step S6 are repeated.

In step S9, the reproduction program and the contents of the optical disc together with the identification code are stored in the memory and the flowchart proceeds to step S10.

In step S10, it is decided whether or not a reproduction key of a remote control device for commanding execution of the reproduction program displayed on the screen of the monitor device is operated, and when the reproduction key of the remote control device is operated, the flowchart proceeds to step S11 and when the reproduction key of the remote control device is not operated, the flowchart proceeds to step S12 and the processing is ended.

In step S11, the reproduction program displayed on the screen of the monitor device is executed and the optical disc is reproduced and the flowchart proceeds to step S12 and the processing is ended.

1. A disc reproducing apparatus capable of simultaneously reproducing an HD layer and a CD layer of an SACD hybrid disc in which the HD layer and the CD layer are formed in a two-layer structure, comprising:
readout means for reading out contents and an identification code of an optical disc;
nonvolatile memory for storing the contents of the optical disc and a reproduction program for reproducing the optical disc together with the identification code of the optical disc;
display means for displaying the reproduction program and the contents of the optical disc, the display means for reading out and displaying the reproduction program and the contents of the optical disc stored in the storage means when the identification code of the optical disc read out by the readout means is stored in the storage means;
contents selection means for selecting the contents reproduced by the reproduction program of the optical disc from among the contents of the optical disc displayed by the display means;
reproduction mode selection means for selecting a reproduction mode of the contents reproduced by the reproduction program of the optical disc displayed by the display means from among a reproduction mode for reproducing two channels of the HD layer, a reproduction mode for downmixing the HD layer into a right channel and the CD layer into a left channel and performing reproduction, a reproduction mode for reproducing the CD layer and a reproduction mode for simultaneously reproducing the HD layer and the CD layer; and
reproduction program execution means for executing the reproduction program of the optical disc and reproducing the optical disc.

2. A disc reproducing apparatus capable of simultaneously reproducing an HD layer and a CD layer of an SACD hybrid disc in which the HD layer and the CD layer are formed in a two-layer structure, comprising:
readout means for reading out contents and an identification code of an optical disc;
storage means for storing the contents of the optical disc and a reproduction program for reproducing the optical disc together with the identification code of the optical disc;
display means for displaying the reproduction program and the contents of the optical disc;
contents selection means for selecting the contents of the optical disc displayed by the display means and selecting the contents reproduced by the reproduction program of the optical disc;
reproduction mode selection means for selecting a reproduction mode of the contents reproduced by the reproduction program of the optical disc displayed by the display means; and
reproduction program execution means for executing the reproduction program of the optical disc and reproducing the optical disc.

3. The disc reproducing apparatus as claimed in claim 2, wherein the display means reads out and displays the reproduction program and the contents of the optical disc stored in the storage means when the identification code of the optical disc read out by the readout means is stored in the storage means.

4. The disc reproducing apparatus as claimed in claim 2, wherein the reproduction mode selection means selects a reproduction mode for reproducing two channels of the HD layer of the SACD.

5. The disc reproducing apparatus as claimed in claim 2, wherein the reproduction mode selection means selects a reproduction mode for downmixing the HD layer of the SACD into a right channel and the CD layer into a left channel and performs reproduction.

6. The disc reproducing apparatus as claimed in claim 2, wherein the reproduction mode selection means selects a reproduction mode for reproducing the CD layer of the SACD.

7. The disc reproducing apparatus as claimed in claim 2, wherein the reproduction mode selection means selects a reproduction mode for simultaneously reproducing the HD layer and the CD layer of the SACD.

8. The disc reproducing apparatus as claimed in claim 2, wherein the storage means is nonvolatile memory.
